(19) United States
(12) Patent Application Publication
(10) Pub. No.: US 2016/0180210 A1
(43) Pub. Date: Jun. 23, 2016

(54) MULTIFUNCTION CONTACTLESS SMART CHIP DEVICE WITH INTEGRATED USER ACTUATED SWITCH

(71) Applicant: Christopher Steele Spears, Houston, TX (US)

(72) Inventor: Christopher Steele Spears, Houston, TX (US)

(21) Appl. No.: 14/664,675

(22) Filed: Mar. 20, 2015

Related U.S. Application Data
(60) Provisional application No. 62/095,759, filed on Dec. 22, 2014.

(51) Int. Cl. G06K 19/077; G06K 19/07; G06K 19/073

(52) U.S. Cl. CPC G06K 19/07701; G06K 19/07754; G06K 19/073; G06K 19/072

(57) ABSTRACT

A push-button enabled contactless transmitting device having a plurality of smart chips that may be switched between by a user to selectively determine the data transmitted through an antenna. The device includes a plurality of smart chips, one or more switches, and an antenna. The device is configured to prevent pre-selected information on the device from being deliberately or accidentally distributed. A method of manufacturing the device includes inlaying the antenna, switches, and smart chips on a single substrate for operation.

### BACKGROUND

1. Field of the Invention

The present application relates generally to an electronic security device, and more particularly to a contactless smart chip device.

2. Description of Related Art

There are many types of wireless transmitting chips in the market. Examples include radio-frequency identification (RFID) chips used to identify and track objects to which it is attached, (2) near field communication (NFC) chips used to enable Smart phones and other electronic devices to establish radio communication with each other via touching them together or bringing them into close proximity for a use, such as making an electronic payment; and (3) HID chips typically seen with keyless entry systems. Each of these chips has the ability to transmit static or dynamic data between itself and a system through transfer protocols known as “contactless” by those familiar within the industry. Smart chip devices are equipped with one of these chips to provide information transfer and authentication between a particular user and an external system. Data transfer may occur without a user being aware and in an uncontrolled manner.

There is a need to provide improved security with the above chips, such as NFC and RFID in particular. Currently, liability for unwanted NFC transmission, in the field of credit cards, falls on the card issuing body. Although this takes liability away from the end user, it still presents costs to the issuer and inconvenience to the end user when security is comprised. In other fields, unwanted NFC transmission can result in a stolen identity or in unwanted trespassers to gain entry into areas protected by contactless security systems. A system in which certain information can be broadcast at any time, and other information can only be broadcast at specified and limited times would be an improvement over existing smart chip technology.

It is desirable to provide a system to permit convenient switching protocol to regulate the transmission of selected information from a plurality of chips to a corresponding external device. Although great strides have been made, considerable shortcomings remain.

### SUMMARY OF THE INVENTION

The present application involves an electronic device configured to contain and include a plurality of smart chips selectively integrated with an antenna to selectively transmit information wirelessly. The device is configured to be shaped having a handheld form factor possibly seen in the use of a keychain or credit card sized entry card.

The electronic device includes a switch to permit a user to select the type and timing of information transmitted via the plurality of chips. The switch is configured to alter the circuit between the antenna and the plurality of chips. The switch permits a user to determine and change which information and/or type of information is transmitted by the electronic device. By activating the switch, the device responds differently to requests by smart card readers. An example of the switch is a momentary switch type. This allows the user to hold a system which has one mode when the switch is not depressed, and another mode when the switch is depressed.

The present application discloses a method of transmissible data switching by switching which chip forms a completed circuit with the antenna. In this configuration, both the active and passive (depressed and undepressed) switch states are configured to place the electronic device in a state where some data is retrievable by a contactless reader.

It is an object of the present application to provide a contactless smart chip device (electronic device) that allows for wireless transmission of different data based upon the state of an onboard switch. The electronic device can be equipped with a plurality of different smart chips that are selectively activated by adjusting the connection between each individual smart chip and an antenna.

It is an object of the present application to provide methods for improving contactless electronic smart chip device security, configurability, and usability.

It is an object of the present application to provide systems for improving contactless electronic smart chip security, configurability, and usability.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is an electronic smart chip device according to the preferred embodiment of the present application;

FIG. 2 is an exemplary schematic of additional hardware included within the electronic smart chip device of FIG. 1;

FIGS. 3A and 3B are schematics of an exemplary embodiment of the electronic smart chip device of FIG. 1 adapted for use on a key chain;

FIGS. 4A and 4B are schematics of an alternative exemplary embodiment of the electronic smart chip device of FIG. 1 being adapted for use on a photo identification card; and

FIG. 5 is a chart illustrating a method of manufacturing the electronic smart chip device of FIG. 1.

While the system and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

The system and method of use in accordance with the present application overcomes one or more of the above-discussed problems commonly associated with perimeter defining devices. Specifically, the device and system of the present application is configured to permit a user the ability to select between transmission of data from two or more smart chips contained within a single device which does not require a battery or other source of on-board power to achieve this functionality. These and other unique features of the system are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

The electronic smart chip device is illustrated in the associated drawings in various different embodiments. The device and system includes a plurality of smart chips in communication with one another. Circuitry relating the smart chips to one another and an antenna are also included. A switch or multiple switches is/are used within the device and system to permit a user to select the smart chip in communication with the antenna, so as to regulate the type of information accessible from external readers and transmitted.

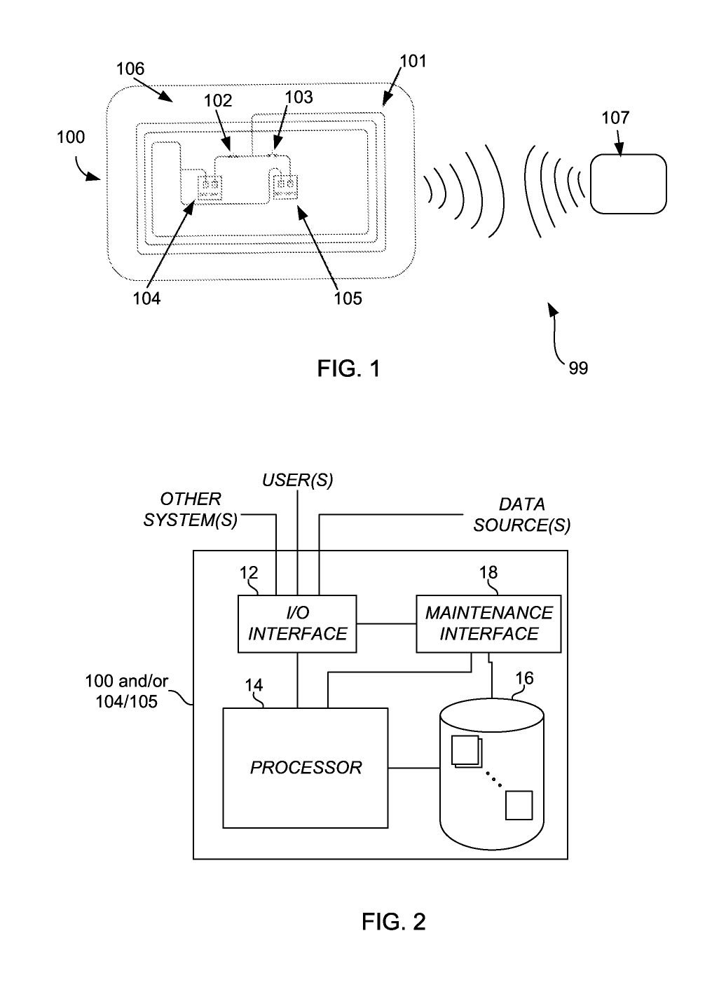

Referring now to the drawings wherein like reference characters identify corresponding or similar elements in form and function throughout the several views. FIG. 1 illustrates an electronic smart chip device 100 in a basic form. A schematic of device 100 is particularly illustrated wherein device 100 includes a first smart chip 104 and a second smart chip 105, a first switch 102 and a second switch 103, an antenna 101 and a substrate 106. Device 100 is configured to permit a user to selectively alternate transmissions between the first smart chip 104 and the second smart chip 105.

Smart chips 104 and 105 are a type of wireless transmitting chip, such as a radio-frequency identification (RFID) chip, a near field communication (NFC) chip, or an HID chip. Smart chips 104 and 105 are not so limited and it is considered within the scope of the present application that smart chips 104 and 105 may be other types of wireless transmission chips for sending and/or receiving data. Smart chips 104 and 105 are configured to communicate with a remote electronic reader device 107 and selectively exchange information wirelessly. In doing so, device 100 is a contactless transmission device. Smart chips 104 and 105 are configured to provide information transfer and authentication with the remote device 107. By activating the one or more switches 102 and 103, a user is able to regulate the transmission of information from chips 104 and 105.

In some embodiments device 100 may be combined with device 107 to form a system 99. System 99 may be sold and operated as a packaged set of items. System 99 may include one or more devices 100 and/or devices 107.

Substrate 106 is configured accept an inlay of the circuitry of device 100 having the antenna, switches, and chips. Substrate 106 may be formed in various different shapes and sizes to fit within design needs of a particular user. As seen in FIG. 1, substrate 106 is formed in the shape of a rectangular credit card, having a similar size, and inlayed with circuitry to communicate chips 104 and 105, switches 102 and 103, and antenna 101. Chip 104 is located on substrate 106 and is configured to store electronic data. Chip 105 is also located on substrate 206 and is also configured to store electronic data. The types of switches that may be used may be momentary switches, both of the push to break type (also known as normally closed) and of the push to make type (also known as normally open). The same functions may be accomplished using one single-pole, double-throw switch (SPDT). Such a SPDT switch can be used by itself or can also be used in conjunction with a momentary normally open switch, used to actuate the SPDT switch. These switches can be of the membrane type, the mechanical type, or of the microelectromechanical systems type (MEMS), depending on desired user interfaces, user experience, or other functionality. Chips 104 and 105 may be identical (of the same type) or different (different type). At least one switch 102 or 103 is used to interrupt communication between chips 104 and 105 and antenna 101 in order to permit a user to select which data is being transmitted to device 107. As illustrated, two switches 102 and 103 may be used where each chip has its own switch. It is understood that other types of switches are considered and the present application is not so limited to those noted above.

Referring now also to FIG. 2 in the drawings, an exemplary embodiment of device 100 is illustrated. Some chips may be configured to store a particular piece of information that is not designed to be fluid or changing from time to time. An example of such information may be identifying information, such as a name or pass code. Other chips may be more intricate and permit for the selective processing of information and also the selective transmission of information depending on device 107. An example may be medical record information, bank information, and so forth. This information is more fluid in that it changes over time and may be configured to present different information depending on the particular device 107 used.

With this in mind, situations may arise where the information needs to be changed or adjusted. Information or data on chips 104 and 105 may be added to, removed from, or modified within each chip. Information or data on each chip may be adjusted in different ways. First each chip may be hard coded with its information, such as identifying data thereby resulting in the need to remove and replace a chip with a different one in order to adjust the information. In another embodiment, chips 104, 105 may be configured to interact with another electronic device through one or more input/output interfaces to permit the exchange and adjustment of the data stored on each chip. This interaction may be performed by the chip itself or through additional processors and hardware within the circuitry of device 100. Use of such chips may not require the removal and replacement of chips 104 and 105 to adjust the data.

FIG. 2 illustrates an exemplary schematic of device 100 with additional hardware included in the circuitry to enable adjustment of the data on chips 104, 105. When included within device 100, this additional hardware may be further included to operate seamlessly with chips 104 and 105, switches 102 and 103, and antenna 101. This may permit device 100 to be integrated within various different platforms to provide additional features. It is understood that chips 104 and 105 may themselves each include the illustrated and described hardware (i.e. processor, storage, input output interface . . . ), thereby avoiding the necessity of including the additional hardware shown in FIG. 2 external to chips 104 and 105.

FIG. 2 illustrates an exemplary configuration and design for the additional hardware for use with device 100, used to adjust information stored and available for transmission via chips 104 and 105 via antenna 101. For description purposes, explanation of the additional hardware will be given using device 100, however as stated previously it is understood that chips 104 and 105 may include some or all of the same additional hardware described within FIG. 2.

The device 100 may further include an input/output (I/O) interface 12, a processor 14, a database 16, and a maintenance interface 18. Alternative embodiments can combine or distribute the input/output (I/O) interface 12, optimization engine 14, database 16, and maintenance interface 18 as desired. Embodiments of device 100 can include one or more computers that include one or more processors and memories configured for performing tasks described herein below. This can include, for example, a computer having a central processing unit (CPU) and non-volatile memory that stores software instructions for instructing the CPU to perform at least some of the tasks described herein. This can also include, for example, two or more computers that are in communication via a computer network, where one or more of the computers include a CPU and non-volatile memory, and one or more of the computer's non-volatile memory stores software instructions for instructing any of the CPU(s) to perform any of the tasks described herein. Thus, while the exemplary embodiment is described in terms of a discrete machine, it should be appreciated that this description is non-limiting, and that the present description applies equally to numerous other arrangements involving one or more machines performing tasks distributed in any way among the one or more machines (i.e. device 100 with reader 107 within a system for example). It should also be appreciated that such machines need not be dedicated to performing tasks described herein, but instead can be multi-purpose machines, for example smart phones, electronic tablets, and computer workstations, that are suitable for also performing other tasks. Furthermore the computers and machines may use transitory and non-transitory forms of computer-readable media. Non-transitory computer-readable media is to be interpreted to comprise all computer-readable media, with the sole exception of being a transitory, propagating signal.

The I/O interface 12 provides a communication link between external users, systems, and data sources and components of device 100. The I/O interface 12 can be configured for allowing one or more users to input information to device 100 via any known input device, such as display 113. Examples can include a keyboard, mouse, touch screen, microphone, and/or any other desired input device. The I/O interface 12 can be configured for allowing one or more users to receive information output from device 100 via any known output device. Examples can include a display monitor, a printer, and/or any other desired output device. The I/O interface 12 can be configured for allowing other systems to communicate with device 100. For example, the I/O interface 12 can allow one or more remote computers to access information, input information, and/or remotely instruct device 100 to perform one or more of the tasks described herein. The I/O interface 12 can be configured for allowing communication with one or more remote data sources, such as device 107. For example, the I/O interface 12 can allow third party 117 to receive performance data transmitted by one or more ways, including: fax, text, email, cloud based upload/download (i.e. world-wide web), to name a few.

The database 16 provides persistent data storage for device 100. While the term “database” is primarily used, a memory or other suitable data storage arrangement may provide the functionality of the database 16. In alternative embodiments, the database 16 can be integral to or separate from device 100 and can operate on one or more computers. The database 16 preferably provides non-volatile data storage for any information suitable to support the operation of device 100. Database 16 stores information to be transmitted within chips 104 and 105 or other information such as authentication information or personal information used to identify the user.

The maintenance interface 18 is configured to allow users to maintain desired operation of device 100. In some embodiments, the maintenance interface 18 can be configured to allow for reviewing and/or revising the data stored in the database 16 and/or performing any suitable administrative tasks commonly associated with database management. This can include, for example, updating database management software, revising security settings, and/or performing data backup operations. In some embodiments, the maintenance interface 18 can be configured to allow for maintenance of processor 14 and/or the I/O interface 12. This can include, for example, software updates and/or administrative tasks such as security management and/or adjustment of certain tolerance settings.

The processor 14 is configured to recognize the type of external communicating device and transmit the proper information/data. Processor 14 may also be used to solely transmit data when antenna 101 is activated. Processor 14 can include various combinations of one or more processors, memories, and software components.

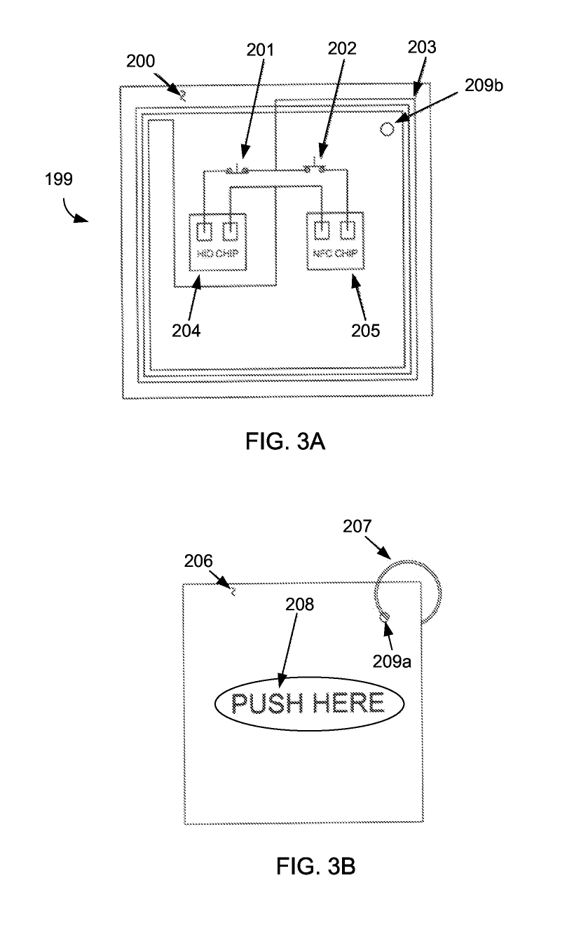

Referring now also to FIGS. 3A and 3B in the drawings, schematics of an embodiment of the electronic smart chip device 100 being adapted for use on a key chain is illustrated. Device 199 is similar in function to that of device 100. Device 199 differs in that it includes an external housing 206 and is adapted for use with a key chain. Housing 206 includes a housing aperture 209a configured to accept a ring 207 to pass through. Substrate 200 is configured to match housing 206 and include a corresponding substrate aperture 209b. Antenna 203, switches 201 and 202, and chips 204 and 205 are similar in form and function to that as described with device 100. Button 208 is shown on housing 206 and is in communication with switches 201 and 202. It is understood that one or more buttons may be used.

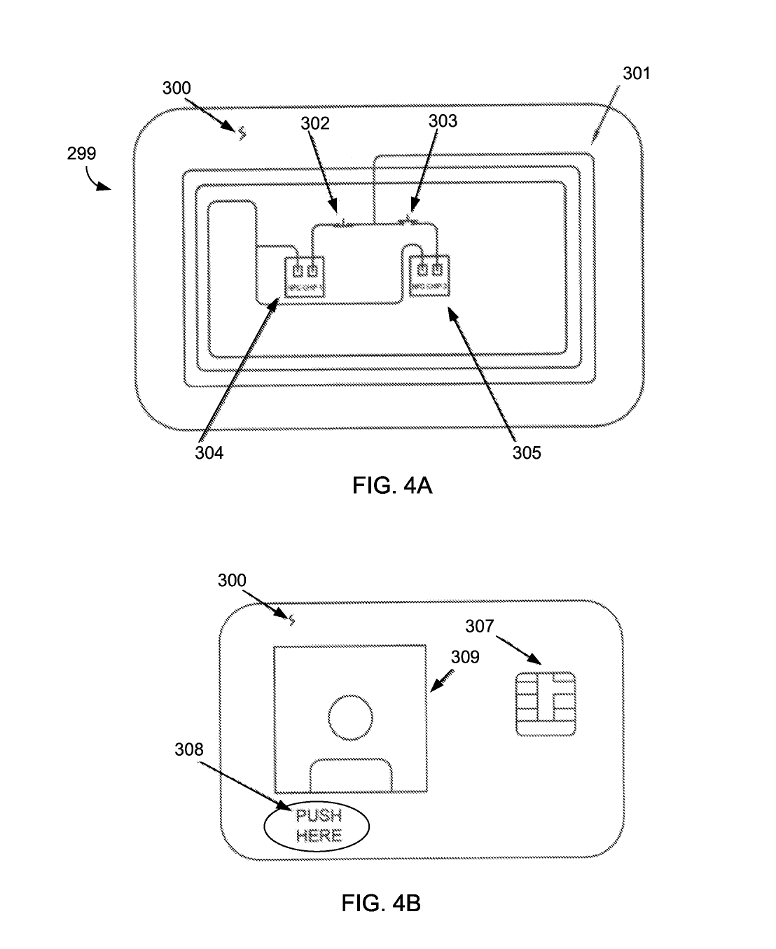

Referring now also to FIGS. 4A and 4B in the drawings, schematics of an alternative exemplary embodiment of electronic smart chip device 100 being adapted for use with a photo identification card is illustrated. Device 299 is similar in form and function to that of device 100. Device 299 differs in that circuitry 301-305 are embedded in a photo identification form factor 306 (i.e. housing or body) with an accompanying EMV or other “contact”-type chip 307. Circuitry 301-305 is not visible to the naked eye through the surfaces of form factor body 306. In this exemplary embodiment, form factor 306 may act as a substrate 300. However other embodiments may separate substrate 300 from body 306. Circuitry 301-305 corresponds to that of circuitry 101-105 of device 100.

A photo identification picture 309 is shown on a front face of body 306. A button 308 is also included. Button 308 is shown on body 306 and is in communication with switches 301 and 302. It is understood that one or more buttons may be used, and that switches 301 and 302 can be combined into one single pole, double throw (SPDT) switch. Body 306 may also include a magnetic stripe, of the type used on credit cards.

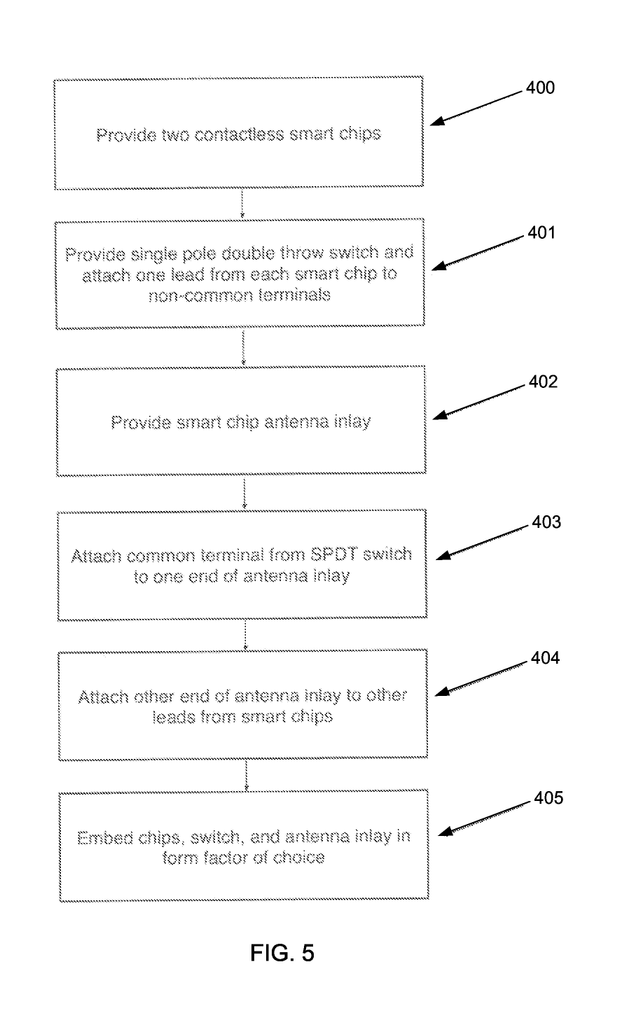

Referring now also to FIG. 5 in the drawings, a chart illustrating a method of manufacturing a particular embodiment of the electronic smart chip device 100 which would use a single pole double throw switch is shown. The first step 400 is to provide two contactless smart chips where the two chips are connected 401 to a switch similar to those described above. The smart chips antenna is provided 402 inlayed into a substrate. Each switch is connected 403 through a first lead to the antenna inlay and the opposing end of the antenna inlay is attached 404 to the second lead of the smart chips. The circuitry is embedded into the desired form factor for use 405.

The current application has many advantages over the prior art including at least the following: (1) use of two smart chips in a single substrate contactless transmitting device; (2) ability to manually switch between the smart chips so as to regulate the particular information transmitted via the antenna; (3) ability for switching between smart chips to be temporary if desired (4) ability to modify information or data on the smart chips; and (5) a method of making such a smart chip device.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. An electronic device, comprising:
a first smart chip located within a substrate and configured to store and transmit data from the first smart chip;
a second smart chip located within the substrate and configured to store and transmit data from the second smart chip;
an antenna in selective communication with the first smart chip and the second smart chip; and
a first switch located within the substrate and in communication with at least one of the first smart chip and the second smart chip, the switch configured to selectively communicate the first smart chip and the second smart chip with the antenna for the transmission of data;
wherein the switch is configured to selectively regulate the transmission of the data from each of the first smart chip and the second smart chip to an external device.

2. The electronic device of claim 1, wherein the first smart chip is at least one of a NFC, HID, and a RFID chip.

3. The electronic device of claim 1, wherein the second chip is at least one of a NFC, HID, and a RFID chip.

4. The electronic device of claim 1, further comprising:
a second switch, the second switch in communication with the second smart chip and the first switch in communication with the first smart chip: wherein the first switch and the second switch are configured to selectively communicate the antenna with the first smart chip and the second smart chip.

5. The electronic device of claim 1, wherein the first switch is at least one of a momentary switch, a single-pole switch, a double-throw switch, and a single-pole, double-throw switch.

6. The electronic device of claim 1, wherein the second switch identical to that of the first switch.

7. The electronic device of claim 1, wherein the second switch is different from that of the first switch in terms of mechanical operation.

8. The electronic device of claim 1, wherein the first switch is at least one of a membrane type, a mechanical type switch, and a microelectromechanical systems (MEMS) type switch.

9. The electronic device of claim 1, wherein activation of the switch disengages the first smart chip from the antenna and communicates the second smart chip with the antenna for transmission of data associated with the second smart chip.

10. The electronic device of claim 1, further comprising:
a body configured so surround the substrate.

11. The electronic device of claim 10, wherein the housing includes a housing aperture for attachment of a ring, the substrate also configured to include a corresponding substrate aperture aligned with the housing aperture;
wherein the ring passes through the housing aperture and the substrate aperture.

12. The electronic device of claim 1, wherein the body is configured to include a photo identification.

13. The electronic device of claim 1, wherein the body is configured to include an EMV or other type of contact-based chip.

14. The electronic device of claim 1, wherein the body is configured to include a magnetic stripe, of the type used on credit cards.

15. The electronic device of claim 1, further comprising:
an electronic reader device configured to receive the data from the first smart chip and the second smart chip through the antenna;
wherein the electronic reader receives the data wirelessly.

16. A method of switching between two contactless smart chips, comprising:
Providing a plurality of smart chips;
Coupling the plurality of smart chips to one or more switches;
Attaching the plurality of smart chips to end of an antenna;
Wherein the one or more switches are configured to select which of the plurality of smart chips is able to transmit data from the antenna.

17. The method of claim 16, wherein the plurality of chips is at least one of a NFC, HID, and a RFID chip.

18. The method of claim 16, further comprising:
a form factor housing configured to surround and protect the one or more switches, the antenna, and the plurality of smart chips.

19. The method of claim 16, further comprising:
adjusting the information data on one of the plurality of smart chips.

20. The method of claim 16, further comprising:
alternating between the plurality of smart chips by operating the one or more switches, so as to select the information being transmitted via the antenna.
